(19) United States
(12) Patent Application Publication
(10) Pub. No.: US 2016/0015018 A1
(43) Pub. Date: Jan. 21, 2016

(54) ENTANGLING HASTATE SETAE FOR PEST CONTROL

(71) Applicant: THE UNITED STATES OF AMERICA, AS REPRESENTED BY THE SECRETARY, DEPARTMENT OF HEALTH AND HUMAN SERV, Atlanta, GA (US)

(72) Inventor: Robert A. Wirtz, Atlanta, GA (US)

(21) Appl. No.: 14/772,973

(22) PCT Filed: Mar. 5, 2014
(86) PCT No.: PCT/US2014/020541

§ 371 Date: Sep. 4, 2015

Related U.S. Application Data
(60) Provisional application No. 61/772,790, filed on Mar. 5, 2013.

(51) Int. Cl. A01M 1/10; A01M 1/20; A01M 1/02; A01M 29/34

(52) U.S. Cl. CPC A01M 1/106; A01M 29/34; A01M 1/20; A01M 1/026

(57) ABSTRACT

Provided are vector traps that effectively entrap a vector, such as an insect, preventing its escape. A vector trap includes one or a plurality of hastate setae that entangle a target. A hastate setae is optionally woven into a substrate material such as insect netting or other surface to prevent the transfer of insect through the netting as well as prevent insects or other vectors that contact the netting from moving away. Also provided are processes of capturing a vector or controlling the prevalence of a vector population in an area.

### CROSS REFERENCE TO RELATED APPLICATIONS

This application claims priority to U.S. Provisional Application Ser. No.: 61/772,790 filed Mar. 5, 2013, the entire content of which are incorporated herein by reference.

### GOVERNMENT INTEREST

The invention described herein may be manufactured, used, and licensed by or for the United States Government.

### FIELD OF THE INVENTION

The invention relates to control of insect disease vectors. More specifically, the application relates to control of mosquitoes that serve as the primary vector for the transmission of pathogens.

### BACKGROUND OF THE INVENTION

Many of the most pervasive human diseases are transmitted from insect, rodent or other living vectors. Malaria, for example, is caused by a Plasmodium parasite transmitted by infective female Anopheles mosquito vector. The World Health Organization estimates that in 2010, 216 million clinical cases of malaria occurred. Of these it is estimated that as many as 1,500 cases occur in the United States.

While much work has been done to address diseases transmitted by insect and rodent vectors, direct vector control is currently the only available method for reducing the transmission of many infectious agents, and remains the only viable method for many others. For example, approaches to diminishing the capacity of a mosquito population to support the transmission of viruses such as dengue viruses include: (i) reducing their overall density (i.e. there are fewer mosquitoes available to transmit the virus), and (ii) reducing their average lifespan (i.e. mosquitoes less likely to live long enough to acquire and transmit the virus).

Chemical treatments are commonly used to control vectors. For example, chemical agents for the reduction of mosquitoes are some of the most commonly employed methods for control of both larval and adult insect populations. Indoor spraying using DDT, pyrethroids (Deltamethrin 2.5% WP, Cyfluthrin 10% WP, Alphacypermethrin 5% WP and Lambdacyhalothrin 10% WP) or Malathion 25% are common. Spraying into the open air or fogging using various chemical agents are used, but are not as effective as would be hoped, due to the large area needed to be treated and the difficulty of obtaining sufficient concentration in that area to contact the insects and be effective.

Using insect netting is one method of personal protection against contact with insects and can also be an effective barrier for rodents. Common insect netting is either standard netting that functions as a physical barrier to insect entry, or is combined with an insecticide included in the material.

Vector netting and traps that utilize pesticides may contribute to the development of insecticide resistance, are less likely to be acceptable to homeowners due to potential health or environmental concerns, and risk becoming productive larval development sites if the insecticide fails to prevent preimaginal development of the vector. Other potential limitations of vector netting and traps is that they serve only as a barrier and do nothing to actually reduce the insect population.

As such, there is a critical need to identify alternative tools and strategies for effective, cost-effective control and surveillance of insect and rodent vectors, or pests.

### SUMMARY OF THE INVENTION

The following summary of the invention is provided to facilitate an understanding of some of the innovative features unique to the present invention and is not intended to be a full description. A full appreciation of the various aspects of the invention can be gained by taking the entire specification, claims, drawings, and abstract as a whole.

The problem of insect or other vector control has proven difficult. The use of insecticides presents the unwanted effects of resistance as well as presenting a health hazard to other inhabitants of the area in wish it is used. The vector traps and processes provided address these issues by trapping vectors in a system that does not require the inclusion of poisons, can be employed safely in any location, can be used on horizontal or vertical surfaces, or hung. A vector trap includes a substrate and a plurality of hastate setae bound to or interwoven with said substrate so as to expose a plurality of barbs configured and oriented so as to contact a vector when the vector contacts the substrate or the hastate setae. A substrate is optionally a surface, a netting, a wall curtain, a wall, the interior of a chamber or portion thereof, or combinations thereof. A substrate is non-living.

The vector traps as provided optionally include hastate setae having a length from 10 micrometers to 1 millimeter, optionally 1 millimeter to 100 millimeters. A hastate setae optionally has a single or a plurality of barbs substantially in a hastate shape. Optionally a hastate setae terminates in a single barb. A hastate setae optionally has a plurality of barbs along the surface of a setae shaft. In some embodiments, barbs are arranged on said hastate setae in a density of 0.01 to 500 per millimeter of length.

A hastate setae in a vector trap is optionally interwoven into a substrate that is an insect netting. A vector trap is optionally configured as an insect bed net.

The hastate setae is optionally derived from one or more donor insects. In some embodiments the hastate setae is formed form one or more synthetic materials.

Also provided are processes of monitoring the presence or absence of a vector in an environmental area including placing a vector trap substantially as above or equivalents thereof in an environmental area and detecting the presence or absence of a vector in said environmental area by the number of vectors associated with said vector trap after a capture time. An environmental area is optionally an outdoor environmental area. In a process a plurality of vector traps are optionally used. Optionally, vector trap(s) are placed at a density of less than or greater than 1 per acre. In some embodiments, a vector trap is placed with one or more additional vector traps at a density of at least two per household.

Also provided are processes of reducing the prevalence of vector borne parasite or virus in an environmental space including placing a vector trap as provided herein or equivalents thereof in an environmental area, and allowing a vector to contact said vector trap so as to become entangled in the hastate setae of the vector trap. Optionally, a vector is an insect. Optionally, a vector trap is configured as a net. A vector trap optionally further includes an insecticide, rodenticide, or combinations thereof.

The vector traps and processes provided herein address the long felt need for an environmentally friendly and safe method of vector control.

### BRIEF DESCRIPTION OF THE DRAWINGS

The following drawings are provided to facilitate an understanding of some of the innovative features unique to the present invention and is not intended to be a full description. A full appreciation of the various aspects of the invention can be gained by taking the entire specification, claims, drawings, and abstract as a whole.

FIG. 1A illustrates one embodiment of a hastate setae configuration used in the formation of a vector trap;

FIG. 1B illustrates one embodiment of a hastate setae configuration woven into a netting structure used as an exemplary vector trap;

FIG. 2A and FIG. 2B illustrate netting material useful for bed netting that is capable of having hastate setae interwoven with the fibers of the netting material so as to form a vector trap according to one embodiment of the invention.

### DETAILED DESCRIPTION OF EMBODIMENTS OF THE INVENTION

The following description of particular embodiment(s) is merely exemplary in nature and is in no way intended to limit the scope of the invention, its application, or uses, which may, of course, vary. The invention is described with relation to the non-limiting definitions and terminology included herein. These definitions and terminology are not designed to function as a limitation on the scope or practice of the invention but are presented for illustrative and descriptive purposes only. While the process and traps are described as an order of individual steps or using specific materials, it is appreciated that described steps or materials may be interchangeable such that the description of the invention includes multiple parts or steps arranged in many ways as is readily appreciated by one of skill in the art.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second (or other) element, component, region, layer, or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

The invention has utility as a system or device for the control or sampling of an insect or animal population. Vector traps are provided that require little to no maintenance and serve to reduce vector populations. The vector traps of the invention are also superior in the ease of use and lack of complexity, each leading to use in inexpensive vector control.

As used herein a “vector” is an organism capable of housing, carrying, or transmitting a disease causing bacteria, virus, or organism. Illustratively, a vector is an insect vector. Although, the invention is described with respect to insect or rodent vectors, it is appreciated that the processes and traps described are equally effective at reducing any insect, rodent or other small mammal or non-mammal populations.

A vector trap is provided that includes a plurality of entangling setae to trap contacting vectors eliminating their ability to spread, and in many embodiments, functions in the absence of any chemical insecticide or rodenticide. The traps employ entanglement setae that are representative of the hastate setae of many beetle species. Beetles use these hastate setae as an entanglement defense mechanism and to incapacitate insects. Processes and traps of the invention use natural or synthetic hastate setae that are woven into the trap substrate material, affixed to a trap substrate material or surface, or combinations thereof.

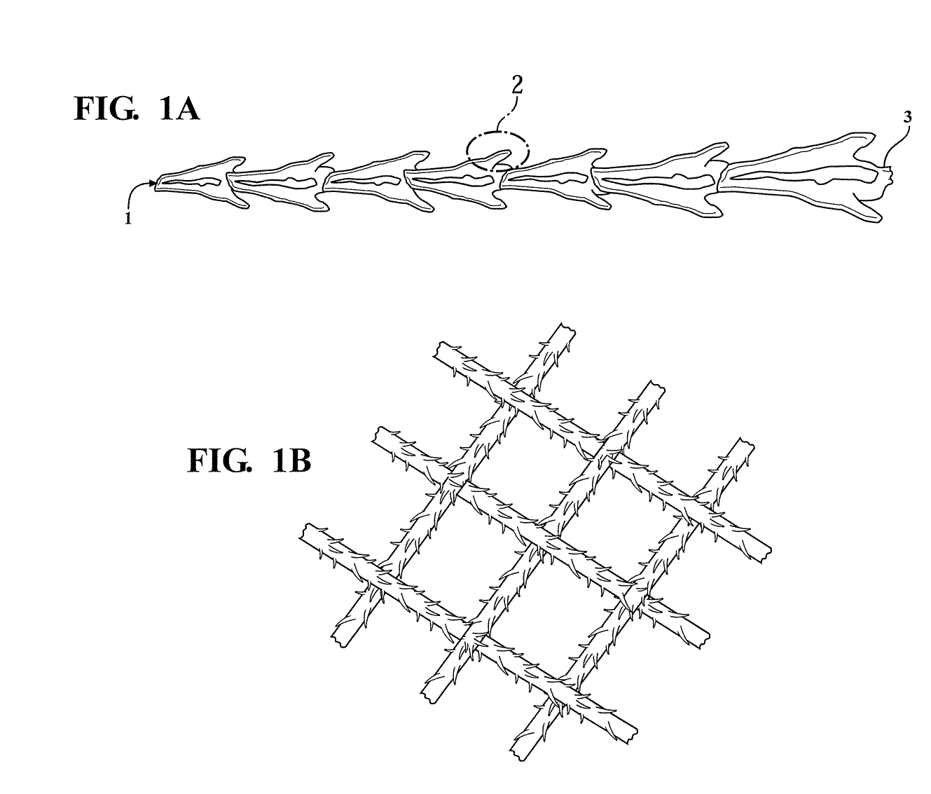

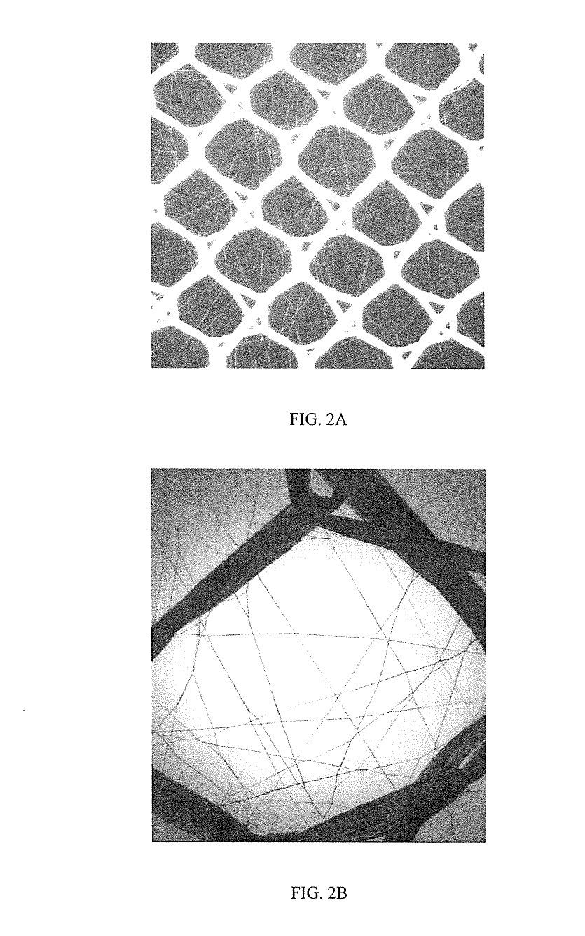

A vector trap is provided that includes a plurality of hastate setae interwoven into or otherwise affixed at one end or a portion of a shaft surface the substrate materials. Hastate setae are barbed, hair-like structures that may have a single barb, or a plurality of barbs lining the shaft. One embodiment of a hastate setae is depicted in FIG. 1. The setae are characterized by a shaft 1 that may or may not include one or more shaft barbs 2 lining the surface of the shaft. A barb may be located facing a proximal end of the shaft or facing a distal end of the shaft, or combinations thereof The distal end may be characterized by a larger single terminal barb 3 that may be oriented opposite a shaft barb or may be oriented in line with a shaft barb. A hastate setae may include a single barb on the terminal end, or may also include one or more shaft barbs along the shaft of the setae depending on the size of the hastate setae, intended use (e.g. for insects, rodents, or other), material used to form the shaft, or as a result of other considerations.

The hastate setae used in the inventions may be of a range of sizes depending on the intended use and target organism. For example, hastate setae typically need to be size-specific. It is appreciated, however, that a single size is effective against a variety of similar sized pests, e.g., mosquitoes, sand flies, midges and small cockroaches. Larger hastate setae are effective against adult roaches and similar sized insects, and even larger setae for bats, rodents, etc. As such, the hastate setae used in the processes and trapping mechanisms of the invention may be sized from 0.01 μm to 10 cm or more in length. Typical shaft lengths for the trapping of small insect vectors such as mosquitoes range from 0.01 μm to 10 mm in length, or any value or range therebetween. Shaft lengths for trapping of larger insects such as cockroaches may be from 0.1 mm to 10 mm, or more. A shaft length is optionally 0.01 μm to 5 mm, 0.01 μm to 3 mm, 0.01 μm to 1 mm, 0.1 μm to 10 mm, 0.1 μm to 5 mm, 0.1 μm to 1 mm, 1 μm to 10 mm, 1 μm to 5 mm, 1 μto 1 mm, 10 μm to 10 mm, 100 μm to 10 mm, 100 μm to 1 mm, or optionally 500 μm to 10 mm.

Typical shaft diameters range from 0.01 nm to 1 mm or more. Shaft diameter is appreciated to be lower than the shaft length so as to produce the characteristic hair-like structure to the hastate setae, an optionally to provide a degree of flexibility.

A hastate setae optionally has a plurality of barbs. The barbs are optionally present at a barb density. A barb density is defined as the number of barbs per unit length of the shaft. Barb density is optionally 1/mm, 2/mm, 3/mm, 4/mm, 5/mm, 6/mm, 7/mm, 8/mm, 9/mm, 10/mm, 12/mm, 15/mm, 20/mm, 30/mm, 50/mm, 100/mm, 200/mm, 300/mm, 400/mm, 500/mm, 600/mm, 700/mm, 800/mm, or more. A barb density is optionally from 1/mm to 500/mm or any value or range therebetween.

A barb has a barb width which is defined as the distance from the shaft to the outer point of the barb at a position perpendicular to the shaft. A barb width is optionally 0.1 μm to 1 mm or more, or any value or range therebetween. A barb width is optionally 0.1 μm to 0.1 mm, 0.1 μm to 100 μm, 0.1 μm to 10 μm, 1 μm to 1 mm, 1 μm to 100 μm, 1 μm to 10 μm, or 0.5 μm to 10 μm. A barb width is optionally any value suitable to trap a target vector.

A hastate setae may include an extension to the shaft that may or may not include a barb. The extension shaft may be used to weave the hastate setae into a substrate material such as a netting material. Many different netting structures can be used for the inclusion of hastate setae interwoven in the netting materials themselves using either the hastate setae shaft or extension shafts connected to the shaft. The hastate setae may be interwoven into netting systems formed by many different processes. Illustratively the hastate setae can be interwoven in the warp knitting process. Alternatively, the hastate setae can be interwoven into bed netting materials such as those produced by Triton Systems, Inc. (Chelmsford, Mass.). Optionally, a vector trap includes at least one barbed filamentary element and a plurality of braided or intertwined unbarbed filaments. The term “braided” is used herein to mean intertwined in any fashion.

The hastate setae are either naturally derived or synthetic. Naturally derived hastate setae can be harvested from a donor organism(s) by known methods. For example, hastate setae can be harvested from the dorsal surfaces of Trogoderma larvae that form prominent dense tufts on the abdominal surfaces. These hastate setae are easily pulled from the insect bodies by contact with an entangling material that can then be removed to obtain hastate setae for incorporation into a vector trap. Any other insect donor that naturally or artificially produces hastate setae may be used as a source of the hastate setae.

Hastate setae may also be formed from synthetic materials. The hastate setae can be formed from one or more polymeric materials such as spin-cast polymer materials, illustratively polypropylene, photoresist, polyimide, glass, polyactide and/or polyglycolide with caprolactone, polyhydroxybutyrate, or epoxy-based compounds. Alternatively, the hastate setae could be formed from a shape memory polymer, such as polyurethane-based polymers, so as to facilitate deployment of the barbs after exposure to the transition temperature of the shaped memory polymer. A polymer can also include spray-deposited polymer materials, such as photoresist, polyimide, glass, or epoxy-based compounds. Alternately, a polymer layer may be an ultra-violet, heat, or air curable epoxy. Artificial hastate setae can also be formed from polymeric materials using 2-dimensional or 3-dimensional printing methods. Illustrative 3-dimensional printing processes include two-photon lithography that is capable of forming 3-dimensional nanostructures on the nanometer size scale. Illustrative printing processes are described by Laza, S C, et. al., Adv. Materials, 2012; 24(10):1304-1308. Other 2 or 3 dimensional printing processes are similarly applicable. One specific illustrative and non-limiting embodiment is a barbed PROLENE strand such as a polypropylene strand manufactured by Ethicon, Inc. of Somerville, N.J. that is subsequently processed to form hastate strucutres along a portion or the entire length of the strand. The strands are then used alone or are braided or interwoven (i.e. as weft or warp position) in a planar material.

Methods of synthetically producing hastate setae with nanostructures and sizing optionally include an oxide/nitride process. The oxide/nitride process may be used by initially etching a recess in a semiconductor substrate. Nitride and oxide layers are then deposited on the substrate. The surface is then patterned with the desired shaping of the hastate setae and etched, resulting in the hastate setae structure. The underlying substrate is etched, resulting in a well. The stress difference between the oxide and nitride layers causes the structure to curl from the plane defined by the substrate forming a shaft structure. The end of the shaft may then be roughened to form a barb or other shape. For example, the barb may be formed by wet etching, radiation, plasma roughening, electro-chemical etching, and the like. Alternately, a separate barbs may be affixed to the shaft. Other methods of forming shaped nanomaterials may also be used including 2-dimensional or 3-dimensional printing methods.

The barbs may be arranged on the hastate setae according to any desired configuration, and can be formed using any suitable method including those well known in the art. These methods may include injection molding, stamping, cutting by knife or laser, press forming or other known methods. According to a preferred method, the barbs are formed by cutting a shaft with any suitable cutting blade or knife. A hastate setae is optionally formed by stamping the shape out of a sheet of material. Optionally, a hastate setae is formed by cutting hastate shapes out of a shaft material such as with a blade, laser, or other cutting instrument.

In some embodiments, a hastate setae is formed by extrusion. For example, a yard or other strand of material is extruded followed by mechanical cutting one or more strands of the extruded material over a portion or the entire length of the strand. Cutting illustratively by mechanical slicing or other mechanism creates angled protruding barbs to form a hastate setae.

The barbs may exist along substantially the entire length L of the hastate setae or along only a portion(s) of the length. Further, any suitable configuration of the barbs relative to shaft can be used in the assembly of the present invention. For example, the barbs are optionally staggered around the circumference of the shaft in any way. A portion of the length of the shaft may also include a second set of barbs facing in a second direction that is greater than 90 degrees from the longitudinal axis of the filament whereas a first set of barbs is facing a direction less than 90 degrees from the longitudinal axis of the filament.

The resulting hastate setae are then included in a netting material, grown or attached to a non-woven substrate surface that may be used to line a vector trap, a window curtain, or wall lining, as a few non-limiting examples. In some embodiments, hastate setae are attached to a substrate by an adhesive suitable for the substrate and hastate setae materials in combination. A hastate setae is optionally woven into a yarn as a single strand component of the yarn or as small interspersed segments interwoven with the other materials of the yarn where the non-barbed strands serve as a substrate. Alternatively, the hastate setae can be used alone and free of a supporting substrate. In either case, the vector contacts the hastate setae and becomes entangled or otherwise prevented from free movement so as to become effectively trapped. The vector can be collected for further study, left to be disposed of, or otherwise treated.

Vector traps are provided that include a plurality of hastate setae included in or on a surface thereof. A vector trap can be a netting, such as a bed netting, window screen, or other netting material or configuration, a surface that is optionally combined with an adhesive or other capture mechanism as is known in the art, or used alone. While the inventive traps provide a mechanism for chemical free vector control, they may also combined with one or more other chemical means for controlling vector populations or penetration. Illustratively, a net can be combined with one or more insecticides, rodenticides, or other chemical agent. A trap may include an attractant material such as decaying matter, or other chemical agent normally found attractive to one or more target vectors. Mechanical trapping mechanisms may also be employed in combination with the hastate setae to assist in capture or elimination of a target vector.

Processes are also provided for reducing or eliminating the presence of a vector in an environmental area. A process includes placing one or more vector traps including a plurality of hastate setae, optionally as described herein, in an environmental area and detecting the presence or absence of an insect vector in the environmental area following a capture time. Detecting is achieved by maintaining the vector trap in the environmental area for a capture time, and determining if a vector is captured by the vector trap by observing the presence or absence of a vector on the surface of the trap that includes the plurality of hastate setae. The presence of a vector in the trap indicates the presence of the vector in the environmental area. The absence of an insect vector in the trap indicates the probable absence of the vector in the environmental area. As a vector trap of the invention does not depend on insecticide to prevent hatching of eggs and elimination of trapped insects and their progeny, the vector traps themselves serve to decrease the number of or eliminate the presence of insects in an environmental area optionally without such additives, although in some embodiments a vector trap further includes one or more insecticides commonly known in the art. The absence of a trapped vector in a vector trap after a capture time optionally indicates the elimination of a vector from the environmental area.

Also provided are processes of monitoring or detecting the presence or absence of one or more vectors in an environmental area. A process optionally includes quantifying the relative number of vectors in an environmental area. A process includes placing a vector trap, optionally as described herein, in an environmental area and detecting the presence or absence of a vector in the environmental area. Detecting is achieved by maintaining the vector trap in the environmental area for a capture time, and determining if a vector is captured by the vector trap by observing the presence or absence of a vector on the hastate setae. The presence of a vector in the trap indicates the presence of the vector in the environmental area. The absence of a vector in the trap indicates the probable absence of the vector in the environmental area.

An environmental area is a defined area that may or may not house or include a target vector. Illustratively, an environmental area is outside exposed to the environment, or inside a house or other building. Optionally, a vector trap such as an insect net is used in an outside environmental area or in an inside environmental area. Optionally, a vector trap is used in an inside environmental area. A vector trap optionally defines a vector free zone that is substantially protected from entry of one or more vectors. Such a vector free zone is optionally surrounding a sleeping area, a tent, a room, a test structure, a cage, or other area. It is appreciated that a plurality of vector traps of the invention are optionally used in a single environmental area. Optionally, an environmental area is one acre, one building, one room of a building, covering a single or plurality of beds, or other configuration. In some embodiments, a plurality of vector traps is placed at a density within an environmental area. A density is optionally at or greater than two per acre, optionally 3, 4, 5, 6, 7, 8, 9, or 10 per acre. A density is optionally 1-2 per room. A density is optionally 1 to 5 per floor of a building, or any value or range therebetween. A density is optionally 1, 2, or 3 per 500 square feet of a single floor.

A capture time is optionally 1, 2, 3, 4, 5, 7, 8, 9, 10, 11, 12, or more days. Capture time will be determined by the target vector, the expected pervasiveness of the vector in the environmental area and likelihood of the vector contacting the vector trap. Optionally, a vector is an insect common to the environmental area. In such circumstances, a capture time may be shorter such as 1-5 days. Optionally, it is expected that only a few vectors are located in an environmental area. In such circumstances, a capture time may be on the order of 5-15 days.

A process optionally includes quantifying the relative number of target vectors in an environmental area. A process optionally includes determining the number of captured vectors after a capture time. The greater number of captured vectors equates to a greater number of vectors in an environmental area.

The vector traps and processes provided herein for the first time address the long felt need for an effective, environmentally friendly, non-destructive to the health or habitat of other organisms contacting or in the area of the vector trap, system for controlling the prevalence of a vector.

### ELEMENT LISTING

Element 1: A vector trap comprising: a substrate; and a plurality of hastate setae bound to or interwoven with said substrate so as to expose a plurality of barbs, said barbs configured and oriented so as to contact a vector when said vector contacts said substrate.

Element 2: The vector trap of element 1 wherein said substrate is a surface, a netting, a wall curtain, a wall, the interior of a chamber or portion thereof, or combinations thereof.

Element 3: The vector trap of element 1 wherein said substrate is non-living.

Element 4: The vector trap of any one of elements 1-3 wherein said hastate setae have a length from 10 micrometers to 1 millimeter.

Element 5: The vector trap of any one of elements 1-3 wherein said hastate setae have a length from 1 millimeter to 100 millimeters.

Element 6: The vector trap of any one of elements 1-3 wherein said hastate setae have a plurality of barbs.

Element 7: The vector trap of any one of elements 1-3 wherein said hastate setae terminate in a single barb.

Element 8: The vector trap of any one of elements 1-3 wherein said hastate setae have a plurality of barbs along the surface of a setae shaft.

Element 9: The vector trap of any one of elements 1-3 wherein said hastate setae are interwoven into an insect netting.

Element 10: The vector trap of any one of elements 1-3 wherein said vector trap is configured as an insect bed net.

Element 11: The vector trap of any one of elements 1-3 wherein said hastate setae are harvested from a donor insect.

Element 12: The vector trap of any one of elements 1-3 wherein said hastate setae are formed from a synthetic material.

Element 13: The vector trap of any one of elements 1-3 further comprising an insecticide, rodenticide, or combinations thereof.

Element 14: The vector trap of any one of elements 1-3 wherein said barbs are arranged on said hastate setae in a density of 0.01 to 500 per millimeter of length.

Element 15: A process of monitoring the presence or absence of a vector in an environmental area comprising: placing a vector trap of any one of elements 1-3 in an environmental area; and detecting the presence or absence of a vector in said environmental area by the number of vectors associated with said vector trap after a capture time.

Element 16: The process of element 15 wherein said environmental area is an outdoor environmental area.

Element 17: The process of element 15 wherein a plurality of said vector traps is placed in an area at a density of greater than one per acre.

Element 18: The process of element 15 wherein said vector trap is placed with one or more additional vector traps at a density of at least two per household.

Element 19: A process of reducing the prevalence of vector borne parasite or virus in an environmental space comprising: placing a vector trap of any one of elements 1-3 in an environmental area; and allowing a vector to contact said vector trap so as to become entangled in said hastate setae.

Element 20: The process of element 19 wherein said vector is an insect and said vector trap is configured as a net.

Element 21: The process of element 19 wherein said vector trap further comprises an insecticide, rodenticide, or combinations thereof.

Element 22: The process of element 19 wherein said hastate setae are configured in any configuration described in the specification.

Element 23: A vector trap as described in the specification, with any combination of elements therein, and equivalents thereof.

Element 24: The processes of any one of claims 15-22 using a vector trap of any one or more of claims 1-14 in any combination.

Element 25: Any combination of one or more elements of claims 1-14.

Element 26: The vector trap of elements 1, 3, 4, 6, and 9.

Element 27: The vector trap of elements 1, 3, 5, 6, and 9.

Element 28: Elements 26 or 27 individually or both in combination with element 12.

Element 29: Element 13 in combination with one or more of elements 4, 5, 6, 12, and optionally 14.

Element 30: Element 14 in combination with one or more of elements 1-13.

Element 31: Element 14 in combination with elements 1, 2, 3, 4, 6, 8, 9 and 12.

Element 32: The combination of element 1, 3, 4, 6, 10, 12, and optionally 13.

Element 33: The process of element 15 further comprising elements 16 and 17.

Element 34: The process of element 15 using the vector trap of any one or more of elements 26-32.

Element 35: The process of element 20 in combination with element 21.

Element 36: The process of element 19 using the vector trap of any one or more of elements 26-32.

Various modifications of the present invention, in addition to those shown and described herein, will be apparent to those skilled in the art of the above description. Such modifications are also intended to fall within the scope of the appended claims.

It is appreciated that all materials are obtainable by sources known in the art unless otherwise specified.

Patents, publications, and applications mentioned in the specification are indicative of the levels of those skilled in the art to which the invention pertains. These patents, publications, and applications are incorporated herein by reference to the same extent as if each individual patent, publication, or application was specifically and individually incorporated herein by reference.

In view of the foregoing, numerous modifications and variations of this invention will be apparent to those of skill in the art. The foregoing discussion, description and examples are meant to be illustrative of the present invention, but are not meant to be limitations upon the practice thereof The following claims, including all equivalents, include additional disclosure related to the full scope of the present inventions.

1. A non-living vector trap comprising:
a substrate; and
a plurality of hastate setae bound to or interwoven with said substrate so as to expose a plurality of barbs, said barbs configured and oriented so as to contact a vector when said vector contacts said substrate.

2. The vector trap of claim 1 wherein said substrate is a surface, a netting, a wall curtain, a wall, the interior of a chamber or portion thereof, or combinations thereof.

3. (canceled)

4. The vector trap of claim 1 wherein said hastate setae have a length from 10 micrometers to 1 millimeter.

5. The vector trap of claim 1 wherein said hastate setae have a length from 1 millimeter to 100 millimeters.

6. The vector trap of claim 1 wherein said hastate setae have a plurality of barbs.

7. The vector trap of claim 1 wherein said hastate setae terminate in a single barb.

8. The vector trap of claim 1 wherein said hastate setae have a plurality of barbs along the surface of a setae shaft.

9. The vector trap of claim 1 wherein said hastate setae are interwoven into an insect netting.

10. The vector trap of claim 1 wherein said vector trap is configured as an insect bed net.

11. The vector trap of claim 1 wherein said hastate setae are harvested from a donor insect.

12. The vector trap of claim 1 wherein said hastate setae are formed from a synthetic material.

13. The vector trap of claim 1 further comprising an insecticide, rodenticide, or combinations thereof.

14. The vector trap of claim 1 wherein said barbs are arranged on said hastate setae in a density of 0.01 to 500 per millimeter of length.

15. A process of monitoring the presence or absence of a vector in an environmental area comprising:
placing a vector trap of claim 1 in an environmental area; and
detecting the presence or absence of a vector in said environmental area by the number of vectors associated with said vector trap after a capture time.

16. The process of claim 15 wherein said environmental area is an outdoor environmental area.

17. The process of claim 15 wherein a plurality of said vector traps is placed in an area at a density of greater than one per acre.

18. The process of claim 15 wherein said vector trap is placed with one or more additional vector traps at a density of at least two per household.

19. A process of reducing the prevalence of vector borne parasite or virus in an environmental space comprising:
placing a vector trap of claim 1 in an environmental area; and
allowing a vector to contact said vector trap so as to become entangled in said hastate setae.

20. The process of claim 19 wherein said vector is an insect and said vector trap is configured as a net.

21. The process of claim 19 wherein said vector trap further comprises an insecticide, rodenticide, or combinations thereof.

22. (canceled)

23. (canceled)

24. (canceled)
